(19) United States
(12) Patent Application Publication
(10) Pub. No.: US 2002/0160811 A1
(43) Pub. Date: Oct. 31, 2002

(54) Radius profiles at a base station and methods of using the radius profiles

(76) Inventors: Michele Ann Jannette, Cardiff, CA (US); Jun Zhu, San Diego, CA (US)

Correspondence Address: SKJERVEN MORRILL LLP, 25 METRO DRIVE, SUITE 700, SAN JOSE, CA, 95110, US

(21) Appl. No.: 09/841,858

(22) Filed: Apr. 25, 2001

(51) Int. Cl. H04M 1/00

(52) U.S. Cl. 455/560; 455/561

(57) ABSTRACT

A system and method for controlling communication between a mobile device and a network server is provided. The system comprises a policy server and a base station controller. The policy server stores a plurality of customer profiles. Each customer profile comprises a customer identifier and at least one customer policy. The base station controller is in communication with the policy server. The policy server is configured to send at least one customer profile to the base station controller. The base station controller is configured to use at least one customer profile from the policy server to control communications between a network server and at least one mobile device used by a customer.

### BACKGROUND OF THE INVENTION

1. Field of the Invention

The present invention relates to a communication system, and more particularly, to a system and method of controlling communication packets.

2. Description of the Related Art

Computers with modems may communicate with a base station and a router, which communicates with an Internet Service Provider (ISP) via a wired communication path. ‘Tunneling’ refers to providing a secure temporary path over an Internet communication path.

### SUMMARY OF THE INVENTION

Radius profiles at a base station and methods of using the radius profiles are provided in accordance with the present invention. The radius profiles help enforce marketing and billing contracts, such as Service Level Agreements (SLAs) between Internet infrastructure wholesalers and Internet Service Provider (ISP) resellers and agreements between resellers and end-users.

One aspect of the invention relates to a system for controlling communication between a mobile device and a network server. The system comprises a policy server and a base station controller. The policy server stores a plurality of customer profiles. Each customer profile comprises a customer identifier and at least one customer policy. The base station controller is in communication with the policy server. The policy server is configured to send at least one customer profile to the base station controller. The base station controller is configured to use at least one customer profile from the policy server to control communications between a network server and at least one mobile device used by a customer.

Another aspect of the invention relates to a method of controlling a communication network. The method comprises sending at least one customer profile to a base station controller. Each customer profile comprises a customer identifier and at least one customer policy. The method further comprises using at least one customer profile from the policy server to control communications between a network server and at least one mobile device used by a customer.

### BRIEF DESCRIPTION OF THE DRAWINGS

FIG. 1 illustrates one embodiment of one embodiment of a communication system with user computers, a wholesaler and a plurality of Internet service providers (ISPs)/resellers.

FIG. 2 illustrates one embodiment of a radius server in the system of FIG. 1 with a plurality of radius profiles.

### DETAILED DESCRIPTION

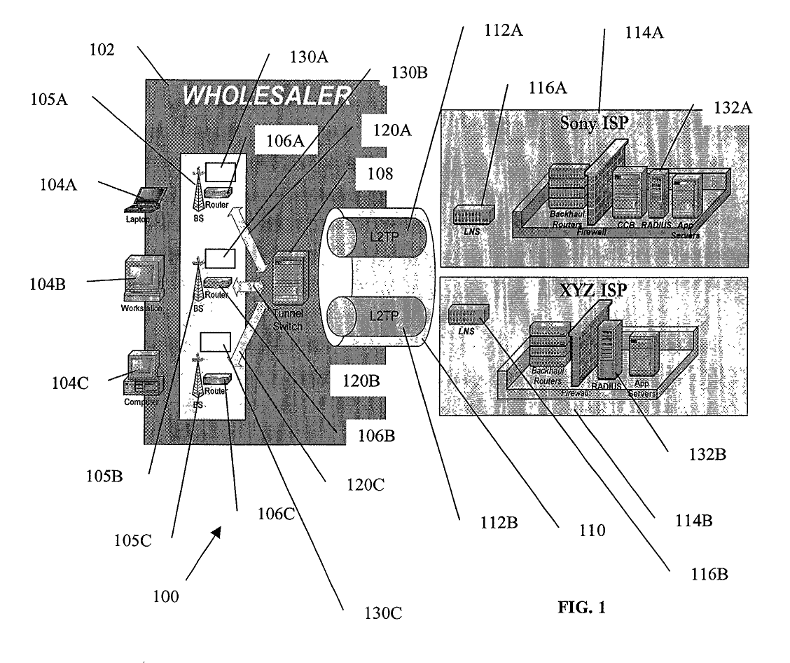

FIG. 1 illustrates one embodiment of a communication system 100 with user computers 104A-104C (referred to herein individually or collectively as ‘computer 104’), a wholesaler 102 and a plurality of ISPs/resellers 114A, 114B (referred to herein individually or collectively as ‘ISP 114’). A ‘user’ may also be referred to herein as a ‘customer’ or a ‘subscriber’ of an ISP 114. An ISP 114 may be located at a Point of Presence (POP) site, where the ISP 114 exchanges traffic and routes packets at Layer 2 of the Open Standards Interconnection (OSI) model. ‘Layer 2’ is the Data Link layer in the (OSI) model. There are seven layers of interconnection in the OSI model. Layer 2 relates to procedures and protocols for operating communication lines.

The wholesaler 102 in FIG. 1 comprises a plurality of base stations (BS) 105A-105C (referred to herein individually or collectively as ‘base station 105’), base station controllers 130A-130C (referred to herein individually or collectively as ‘base station controller 130’), routers 106A-106C (referred to herein individually or collectively as ‘router 106’), communication paths 120A-120C (referred to herein individually or collectively as ‘communication path 120’), and a tunnel switch 108. The system 100 in FIG. 1 may comprise any number of computers 104, base stations 105, base station controllers 130, routers 106, tunnel switches 108 and ISPs 114.

A first computer 104A in FIG. 1 may be a laptop. Second and third computers 104B-104C may be workstation or desktop computers. In other embodiments, the computers 104A-104C may be personal digital assistants (PDAs), such as a Palm™ 500 made by Palm, Inc., home appliances, audio/video devices, mobile phones or any device that transmits and receives packets of information.

Each computer 104 is coupled to a wireless modem (not shown) or has a built-in wireless modem, which may or may not use access numbers. Each wireless modem is configured to transmit and receive signals with a base station 105 via an analog or digital wireless communication standard, such as Global System for Mobile Communications (GSM), Code Division Multiple Access (CDMA) or Time Division Multiple Access (TDMA). The signals from each computer 104 with a wireless modem to a base station 105 may comprise an email or a request for Internet content, such as a motion picture, a music video or a video game. The signals from a base station 105 to a computer 104 may comprise an email or Internet content, such as a motion picture, a music video or a video game.

Each base station 105 in FIG. 1 provides wireless communications between the computers 104A-104C and the ISPs 114A-1 14B. Each base station 105 may be referred to as a ‘first aggregation point of connectivity’ for different modem terminals. In one embodiment, each base station 105 may maintain substantially continuous wireless communication channels with modems coupled to the computers 104A-104C, which are within a communication range of the base station 105. Thus, the communication channel between the computers 104A-104C and the base station 105 may be referred to as ‘always on,’ even when a user is not actively using a computer 104. In one embodiment, the system 100 uses the ‘i-BURSTTM™’ personal broadband wireless Internet access system developed by ArrayComm in San Jose, Calif.

In one embodiment, each base station controller 130 in FIG. 1 comprises a controller and a memory. Each base station controller 130 is coupled to a router 106. In another embodiment, the functions of a base station controller 130 described below are implemented with pre-existing equipment at a base station 105, such as a router 106. In one embodiment, each base station controller 130 aggregates wireless packets, such as Internet Protocol (IP) packets or i-Burst™ packets, before they are encapsulated with a Layer 2 Tunneling Protocol (L2TP) layer and transmitted to the tunnel switch 108. ‘L2TP’ is a protocol developed by the Internet Engineering Task Force (IETF) to provide secure, high-priority, temporary paths through an Internet network. In one embodiment, the base station controllers 130A-130C pass packets from the mobile devices 104A-104C to the routers 106A-106C.

Each router 106 in FIG. 1 may be implemented at a base station 105, coupled to a base station 105 or in communication with a base station 105. In one embodiment, the router 106 is manufactured by Cisco Systems, Inc. Each router 106 operates with a base station controller 130 to route data packets between a base station 105 and the corresponding tunnel switch 108 via a communication path 120.

The communication paths 120A-120C may comprise physical media, such as one or more twisted wire pair cables, coaxial cables or fiber optic cable, which may use a communication standard or protocol, such as T-1, Digital Service 3 (DS-3) or DS-4. Alternatively, the communication paths 120A-120C may be wireless. The paths 120A-120C carry data packets between the routers 106A-106C and the tunnel switch 108. Data packets from the routers 106A-106C to the tunnel switch 108 are herein referred to as ‘upstream,’ and data packets from the tunnel switch 108 to the routers 106A-106C are referred to as ‘downstream.’

The tunnel switch 108 in FIG. 1 is an aggregation point that is configured to manage data packets from a number of different base stations 105A-105C. The tunnel switch 108 directs signal channel traffic between the user computers 104A-104C and corresponding resellers/ISP's 114A-114B via a wired communication path 110. In one embodiment, the tunnel switch 108 uses a first L2TP and/or Virtual Private Network (VPN) interface 112A to direct user' signal traffic to the first ISP 114A and a second L2TP and/or VPN interface 112B to direct user' signal traffic to the second ISP 114B. A VPN is a software-defined network that has the appearance and functionality of a dedicated private network.

Each ISP 114 in FIG. 1 has a L2TP network server (LNS) 116 for each tunnel switch 108. Each LNS 116 controls Internet Protocol, Point-to-Point Protocol (PPP) and L2TP functions. PPP is a protocol that allows a computer to access the Internet with a high speed modem and features error detection, data compression and other communication protocols. Each LNS 116 decapsulates L2TP packets and performs Authentication, Authorization and Accounting (AAA) functions for each data packet that requests network services from an ISP 114.

In general, each customer selects a quality of service (QoS) level or usage from an ISP 114. The selected QoS is defined in the customer's Service Level Agreement (SLA) with an ISP 114. QoS classifies IP packets for traffic flow management on network links. For example, there may be three types of QoS, such as bronze, silver and gold. A ‘gold’ subscriber would ideally have the highest level of QoS, i.e., highest priority. Each ISP 114 is expected to provide (but does not always deliver) a QoS level to each customer, as specified by each customer's SLA.

For example, 500 customers each contract for a 1Megabit per second (Mbps or Mb/s) downstream access (and 4Kb/s upstream access) from the first ISP 114A, and 10 customers each contract for 2Mb/s access from the second ISP 114B. If the computers 104 of the 500 customers share the same base station 105A with the computers 104 of the 10 customers, then all of the customers may have the same data throughput eventually (if a control profile method is not implemented to control high priority packet services). There is no guarantee that one customer will receive the requested bandwidth according to the customer's SLA because current base station controller architectures cannot apply guaranteed customer delivery.

### Radius Server 132

Each ISP 114 in FIG. 1 has a radius policy server (or ‘radius server’) 132. Each radius server 132 may be located at an ISP's central site (e.g., Network Operations Center (NOC)) or off-site at a selected location. Each ISP may use more than one radius server 132. In one embodiment, each radius server 132 handles requests that are sent to a Lightweight Directory Access Protocol (LDAP) server (not shown). LDAP is based on the International Telecommunications Union-Telecommunications Service Sector (ITU-T) X.500 standard and may be installed on disparate, legacy email directories, network operating system directories and databases.

The radius servers 132A-132B in FIG. 1 control Authentication, Authorization and Accounting (AAA) functions for data packets received by the base stations 105A-105C from the computers 104A-104C. Each radius server 132 in FIG. 1 stores a database of ‘radius-configured profiles’ (also referred to herein as ‘radius profiles,’ ‘radius control policies,’ ‘radius-controlled policies’ or ‘policy profiles’).

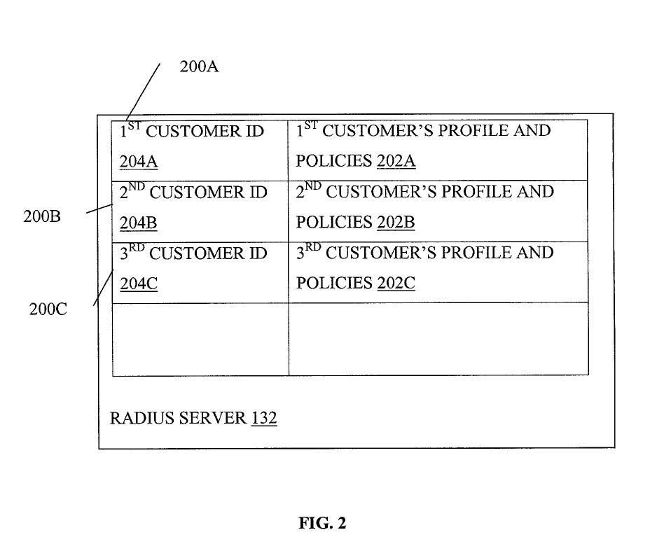

FIG. 2 illustrates one embodiment of a radius server 132 in FIG. 1 with a plurality of radius profiles 200A-200C (referred to herein individually or collectively as ‘radius profile 200’). Each radius profile 200 comprises a customer ID (the key field) 204 (referred to herein individually or collectively as ‘customer ID 204’), such as a customer login ID, and customer-specific profiles and policies 202 (referred to herein individually or collectively as a ‘profiles and policies 202’) as secondary fields. A ‘login’ is a request from a user computer 104 for an IP/PPP session to be authenticated and authorized to use the resources of an ISP 114.

The profiles and policies 202 describe a selected QoS usage level for each customer, such as gold, silver or bronze levels. For example, a bronze customer may have the smallest bandwidth, and during times of congestion at the base station 105, the bronze customer's data packets may have the lowest priority and the highest probability of being dropped (discarded). In addition to dedicated bandwidth, e.g., a 1 Mbps or 2 Mbps, the profiles and policies 202 may indicate other customer preferences, parameters and SLA contract terms, such as a static IP address (in an IP header), an amount of dedicated processing power or a number of video streams available to a particular customer. The profiles and policies 202 may be changed by the customer and an ISP 114.

Each radius server 132 in FIG. 1 is configured to send one or more of the radius profiles 200 to any router, such as an edge router 106, and/or any controller, such as the base station controllers 130A-130C. An ‘edge’ router or ‘border’ router is a router that first receives IP packets from a customer's mobile device 104 in a communication network. In one embodiment, each radius server 132 is configured to send one or more radius profiles 200 to a base station controller 130, which aggregates wireless packets before they are encapsulated with an L2TP layer.

Each radius server 132 may send a radius profile of a particular customer to a base station controller 130 when, for example, (1) the customer's computer 104 moves within a communication range of a base station 105, (2) one base station 105 hands off communication with the customer's computer 104 to another base station 105, (3) the base station 105 recognizes the customer's computer 104 within the base station's communication range, or (4) when the ISP 114 authenticates a login from the customer's computer 104.

In one embodiment, each base station controller 130 is configured to store one or more radius profiles 200 in a non-volatile memory (not shown), which is in the base station controller 130 or coupled to the base station controller 130.

If the customer's computer 104 moves out of communication range with the base station 105, the base station controller 130 may purge (or erase) the currently loaded radius profile 200 after a configurable period of time has passed. The software or transmission protocol used by a radius server 132 to deliver radius profiles to base station controllers 130A-130C may be called a ‘radius interface.’

Each radius policy server 132 and/or its radius profiles 200 may be configured to perform a plurality of synched functions, such as (1) traffic classification, e.g., high vs. low priority, control vs. data packets, voice, data, video streaming, email or other classifications, (2) management of queued sessions, e.g., in a router 106 or base station controller 130, (3) traffic congestion control, and (4) congestion avoidance. A user may be simultaneously sending and receiving packets related to various types of sessions, such as voice, data and video signal sessions, which are queued in separate queues.

Each radius server 132 helps enforce IP packet prioritization, i.e., ensures end-to-end delivery of ‘QoS sessions,’ which are communication sessions between a computer 104 and an ISP 114 according to a predetermined QoS level. IP packet prioritization is important for value-added services, such as Voice over Internet Protocol (VoIP), real-time streaming video and up-to-date gaming experiences. These value-added services may require detail in delivery. Thus, some services or applications have a predetermined preference rating, which is a timing factor of when particular packets should arrive at a destination.

### Base Station Controller 130

Each base station controller 130 in FIG. 1 executes a software module called a ‘routing protocol interface’ which considers the radius-configured profiles 200 from the radius servers 132A-132B to control and filter packet routing. The routing protocol interface has an ‘inbound’ interface and an ‘outbound’ interface. ‘Inbound’ describes packets from the tunnel switch 108. ‘Outbound’ describes packets to the tunnel switch 108. Configuration features at the inbound and outbound interfaces are defined such that an appropriate routing interface is applied before a wrapper (software filter) masks IP Class of Service header information in a packet.

Each routing protocol interface at a base station controller 130 has an ‘early detection process’ and/or a buffering flow silo which applies the radius profiles 200 to throttle (i.e., allocate) bursty dynamic bandwidth if the routing protocol interface becomes congested. An early detection process prevents bottlenecks at a base station 105. Each radius profile defines a ‘traffic session threshold’ for the routing interface to allocate bandwidth (a ‘traffic session threshold’ may also be called a ‘bandwidth controlling factor’ or ‘bandwidth allocation factor’). Bandwidth allocation at each base station 105 is important because bandwidth allocation defines a customer's initial application session needs. The inbound and outbound interfaces analyze the packets to determine which packets to send, drop or queue at a base station controller 130 for IP traffic delivery.

In operation, when a base station 105 carries a user's session, the routing protocol interface at the base station controller 130 acknowledges the traffic session thresholds defined in the radius profiles. If congestion occurs, the routing protocol interface implements a ‘shaping policy,’ for example, to allocate more bandwidth for high-priority (premium) traffic flows (e.g., voice or video) compared to high-bandwidth, low-priority traffic flows. A shaping policy provides separate thresholds and weights for different IP precedences (e.g., high vs. lower priority) that are obtained from the radius profiles 200. An early detection process applies a shaping policy using the radius profiles 200. Shaping policies allow an ISP 114 to provide different QoS levels for different traffic. During periods of congestion, the shaping policy may drop low-priority traffic (e.g., emails) more frequently than premium high-bandwidth traffic (e.g., voice or video).

An example of a shaping policy is the Weighted Random Early Detection (WRED) process available on a Cisco 12000 Series Router. WRED differs from Random Early Detection (RED) because RED is a congestion avoidance module that uses a Transmission Control Protocol (TCP) congestion control mechanism. RED randomly drops packets prior to periods of high congestion and instructs a packet source to decrease its transmission rate. If the packet source is using TCP, the packet source will decrease its transmission rate until all packets reach their destination(s), which indicates the congestion has cleared. In contrast, WRED drops packets selectively based on IP precedence. Packets with higher IP precedence are less likely to be dropped than packets with a lower precedence. Thus, higher priority traffic has a higher probability of being delivered than lower priority traffic. According to the invention, a base station controller 130 or a router 106 may apply WRED with IP precedences obtained from the radius profiles 200.

A shaping policy is useful on any output interface where congestion may occur. Shaping policies, such as WRED, have been used at ‘core’ routers, rather than ‘edge’ routers. In accordance with the present invention, base station controllers 130A-130C assign and an IP precedence, e.g., high or lower priority, to packets as they enter a network via the edge routers 106A-106C. For example, a base station controller 130 in FIG. 1 may insert a code for a particular IP precedence in each packet. The routers 106A-106C read the code.

‘Core’ routers are routers that are at or near an LNS 116. Core routers may use a shaping policy, such as WRED, to determine how to treat different types of traffic.

In FIG. 1, a shaping policy would be beneficial at edge routers because the system 100 uses a tunnel switch 108, and IP filtering is no longer functional at the Layer 2 level. Both core and edge routers in the system 100 of FIG. 1 advantageously use shaping policies in accordance with a plurality of customer profiles 200. The levels of a shaping policy may be defined separately on core and edge routers.

The routing protocol interface at each base station controller 130 is a key to providing premium QoS services, such as QoS services to a premium customer or a premium application, such as Voice over Internet Protocol (VoIP), real-time streaming video and up-to-date gaming experiences. The routing interface at each base station controller 130 should perform a number of functions. For example, the routing interface at each base station controller 130 may act as a Policy Enforcement Point (PEP) with direction from the radius policy servers 132A-132B to accept or reject IP requests, such as Resource Reservation Protocol (RSVP) requests. RSVP is an IETF standard that supports reservations for resources, such as bandwidth, through networks of varying topologies and media. After radius profiles 200 are sent to a base station controller 130, the base station controller 130 may implement RSVP (or a process similar to RVSP) which utilizes the user policies in the radius profiles 200.

As another example, the routing interface at each base station controller 130 may analyze IP header precedence and aggregate traffic flows for Differentiated Services (DS), which is a IP protocol which classifies services, packets or frames. Differentiated Services can be analyzed by a Subscriber Management System (SMS) box for transmission to ‘border routers’ or a VoIP gateway, which is piece of equipment that communicates with a border router. A SMS box is typically located at a core router or at an ISP's core facilities. One embodiment of a SMS box is made by Redback. QoS may be implemented at the Layer 2 level with point-to-point access links and switches.

As another example, the routing interface at each base station controller 130 may implement a weight factor ratio and/or control how frequently packets are dropped.

As another example, the routing interface at each base station controller 130 may provide ‘traffic shaping,’ i.e., control an amount of bandwidth that a traffic session requires. Thus, the routing interface at each base station controller 130 acts as a QoS filter.

As another example, the routing interface at each base station controller 130 may control a L2TP layer and how a QoS session is signaled by RSVP and Differentiated Service.

In one embodiment, the routing interface at each base station controller 130 is configured to perform all of the above-described functions. Thus, with IP preference and WRED packet action, the routing interface at each base station controller 130 prevents flooding (congestion) and increases the overall bandwidth usage for high-priority traffic sessions. Thus, each base station controller 130 can control data packet routing when the base station 105 becomes congested.

The above-described embodiments of the present invention are merely meant to be illustrative and not limiting. Various changes and modifications may be made without departing from the invention in its broader aspects. The appended claims encompass such changes and modifications within the spirit and scope of the invention.

What is claimed is:

1. A communication system comprising:
a policy server storing a plurality of customer profiles, each customer profile comprising a customer identifier and at least one customer policy; and
a base station controller in communication with the policy server, wherein the policy server is configured to send at least one customer profile to the base station controller, the base station controller configured to use at least one customer profile from the policy server to control communications between a network server and at least one mobile device used by a customer.

2. The system of claim 1, wherein the base station controller is coupled to a router.

3. The system of claim 1, wherein the base station controller comprises a router.

4. The system of claim 1, wherein each customer policy comprises a quality of service (QOS) usage level for a customer.

5. The system of claim 1, wherein each customer policy comprises a network bandwidth limit for a customer.

6. The system of claim 1, wherein each customer policy specifies an Internet Protocol precedence level for at least one type of packet.

7. The system of claim 1, wherein each customer profile comprises a static Internet Protocol address.

8. The system of claim 1, wherein each customer policy comprises a dedicated amount of processing power.

9. The system of claim 1, wherein each customer policy comprises a number of video streams available to a customer.

10. The system of claim 1, wherein each customer policy comprises at least one traffic classification.

11. The system of claim 1, wherein each customer policy comprises at least one traffic control policy.

12. The system of claim 1, wherein each customer policy comprises at least one traffic congestion policy.

13. The system of claim 1, wherein each customer profile is configurable by a customer.

14. The system of claim 1, wherein the base station controller is configured to use at least one customer profile from the policy server to control network bandwidth between a network server and at least one mobile device used by a customer.

15. The system of claim 1, wherein the base station controller is configured to use at least one customer profile from the policy server to determine a frequency of dropping packets transmitted between at least one customer and the network server.

16. The system of claim 1, wherein the communications between a network server and at least one mobile device used by a customer comprises voice, data and video packets.

17. The system of claim 1, wherein the base station controller executes a shaping policy and an early detection process that uses at least one customer profile to allocate network bandwidth.

18. The system of claim 1, wherein the policy server is configured to send a customer profile to the base station controller when a customer's mobile device is within a communication range of the base station controller.

19. The system of claim 1, wherein the policy server is configured to send a customer profile to the base station controller when a customer initiates communication with the network server.

20. The system of claim 1, wherein the base station controller is configured to store at least one customer profile.

21. The system of claim 1, wherein the network server comprises a Layer 2 Tunneling Protocol network server.

22. A server configured to control a plurality of customer profiles, each customer profile comprising a customer identifier and at least one customer policy, wherein the server is configured to send at least one customer profile to a base station controller, the base station controller configured to use at least one customer profile from the policy server to control communications between a network server and at least one mobile device used by a customer.

23. A method of controlling a communication network, the method comprises:
sending at least one customer profile to a base station controller, each customer profile comprising a customer identifier and at least one customer policy; and
using at least one customer profile from the policy server to control communications between a network server and at least one mobile device used by a customer.
